(19) United States
(12) Patent Application Publication
(10) Pub. No.: US 2005/0278309 A1
(43) Pub. Date: Dec. 15, 2005

(54) System and method for mining and searching localized business-marketing and informational data

(76) Inventors: Perry Evans, Littleton, CO (US); Susan Dalton, Englewood, CO (US); Michael Bauer, Denver, CO (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/858,947

(22) Filed: Jun. 2, 2004

(51) Int. Cl. G06F 7/00

(52) U.S. Cl. 707/3

(57) ABSTRACT

A system and method for searching records. One embodiment includes a method for searching comprising: receiving a search a term comprising a product term and a geography limitation; identifying a normalized term corresponding to the product term; identify a first set of records corresponding to the normalized term; sorting the first set of records according to the geography limitation; returning at least some of the first set of records according to the sort; identifying navigation links corresponding to the normalized term; identifying a second set of records corresponding to at least one of the navigation links; and returning at least some of the second set of records.

### COPYRIGHT

This patent document contains material that is subject to copyright protection. The copyright owner has no objection to the reproduction by anyone of the patent disclosure as it appears in the Patent and Trademark Office patent files or records but otherwise reserves all copyright rights whatsoever.

### FIELD OF THE INVENTION

The present invention relates to systems and methods for managing and processing business information. In particular, but not by way of limitation, the present invention relates to systems and methods for identifying, extracting and/or processing unstructured and structured business information, including yellow-pages advertisements, Web sites, newspaper advertisements, free standing inserts, etc.

### BACKGROUND OF THE INVENTION

Yellow pages, newspapers, free standing inserts and the like have been a key link between businesses and their customers for decades. These documents contain the information that businesses want to convey to their potential customers and are often the only link between customer and business.

The individualized presentation in many print documents results in voluminous amounts of non-structured data. A typical yellow-pages book, for example, contains thousands of advertisements with little or no common structure or language. One business, for example, could advertise that it is “open Weekends.” Another could advertise that it is “open 365 days a year.” The typical reader quickly realizes that both businesses are open on Saturdays even though the ads do not expressly say so. Electronic search engines, however, have considerable difficulty in making the same determination.

For many consumers, manually searching traditional, print yellow pages is undesirable. These consumers want to electronically search for business information that they would normally find in print yellow pages. For several reasons, traditional, electronic search methods are inadequate for these business searches. First, traditional search engines do not have a complete picture of local businesses. Many businesses purchase advertisements in the yellow pages and newspaper but never create a Web page. And unless a business has a Web page, traditional search engines cannot generally identify that business. Second, traditional search engines often use pay-for-placement and relevance models for listing businesses. So even if a small business has a Web site, traditional search engines could minimize its importance in favor of a larger business that pays more for placement in the search results. For example, if a consumer is searching for an auto mechanic in San Jose, traditional search engines might identify major auto dealerships that have their own Web sites but would likely fail to identify the small, neighborhood mechanic that has a recently constructed, basic Web site.

The problems with traditional search engines and business searches extend beyond their lack of knowledge about yellow-pages content. Traditional search engines do not properly handle other sources of print advertisements such as newspaper advertisements and free standing inserts. For example, if a local business is offering a special on oil changes, that information would typically be distributed in a newspaper, free-standing insert, email, and/or a direct-mail coupon. Traditional search engines are limited in their ability to search for or identify this type of promotion. Thus, if a consumer is searching for “oil change, San Jose, coupon,” traditional search engines cannot generally help unless the coupon is advertised on a Web site.

Because current technology is ineffective for local searches, systems and methods are needed to make business and other unstructured information electronically available and intelligently searchable. Systems and methods are also needed to intelligently present this local information to the user.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

One embodiment includes a method for searching records. This method involves receiving a search a term comprising a product term and a geography limitation; identifying a normalized term corresponding to the product term; identifying a first set of records corresponding to the normalized term; sorting the first set of records according to the geography limitation; returning at least some of the first set of records according to the sort; identifying navigation links corresponding to the normalized term; identifying a second set of records corresponding to at least one of the navigation links; and returning at least some of the second set of records.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are more readily appreciated by reference to the following Detailed Description and to the appended claims when taken in conjunction with the accompanying Drawings wherein:

FIG. 1 is an illustration of a local search enabled by one embodiment of the present invention;

FIG. 2 is the result of a local search performed by one embodiment of the present invention;

FIG. 3 is another result of a local search performed by one embodiment of the present invention;

FIG. 4 is an active marketing page returned with results of a local search performed by one embodiment of the present invention;

FIG. 5 is an example of an inline advertisement returned with the results of a local search performed by one embodiment of the present invention;

FIG. 6 is an example of the content collected from an advertisement by an embodiment of the present invention;

FIG. 7 is a chart illustrating a taxonomy for organizing business data collected from print advertisements, Web sites, and similar data sources;

FIG. 8 is a chart showing exemplary relationships between portions of a taxonomy used to organize local data;

FIG. 9 is a block diagram of an architecture corresponding to one embodiment of the present invention;

FIG. 10 is a flowchart of one method for operating an embodiment of the present invention;

FIG. 11 is an example of an aggregated advertisement placement performed by one embodiment of the present invention;

FIG. 12 is a block diagram of one architecture for performing aggregated advertisement placement;

FIG. 13 is a flowchart of one method for creating business records using the DKB;

FIG. 14 is a flowchart of a method for crawling structured data using the DKB to create or supplement business records;

FIG. 15 is a flowchart of one method for searching for businesses using the DKB; and

FIG. 16 is a flowchart of another method for searching for businesses using the DKB.

### DETAILED DESCRIPTION

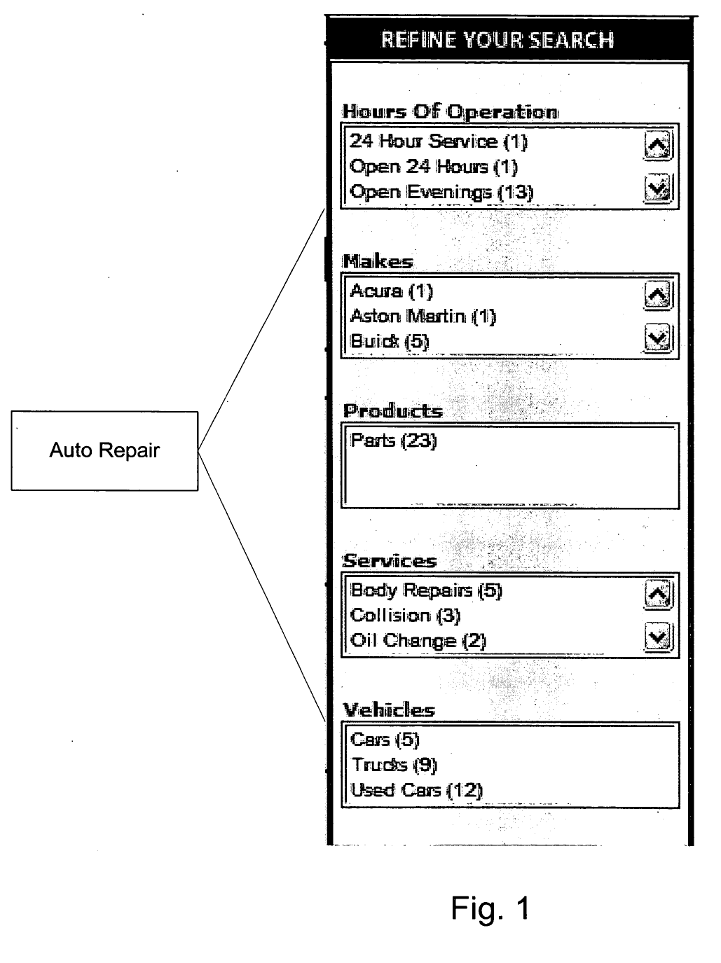

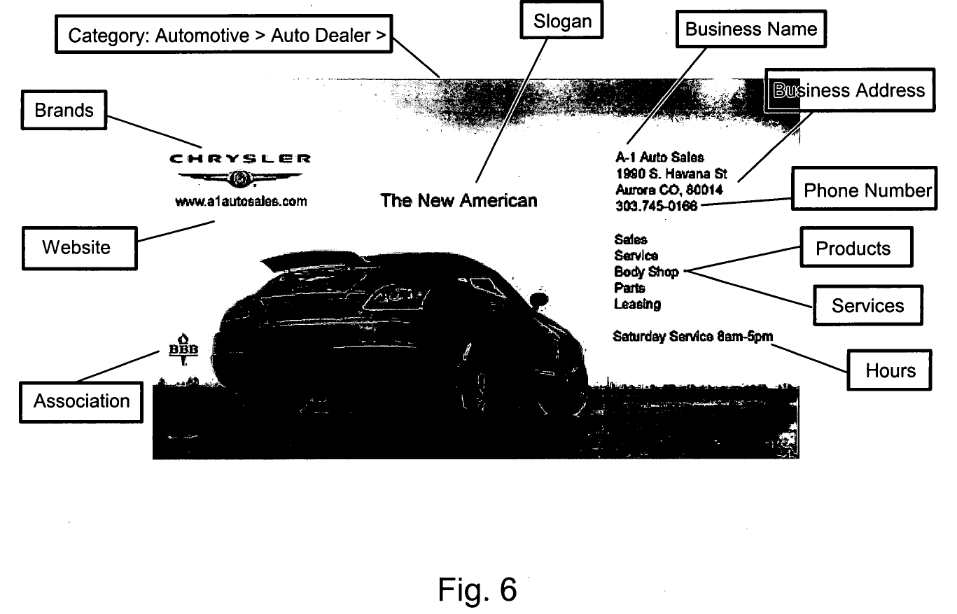

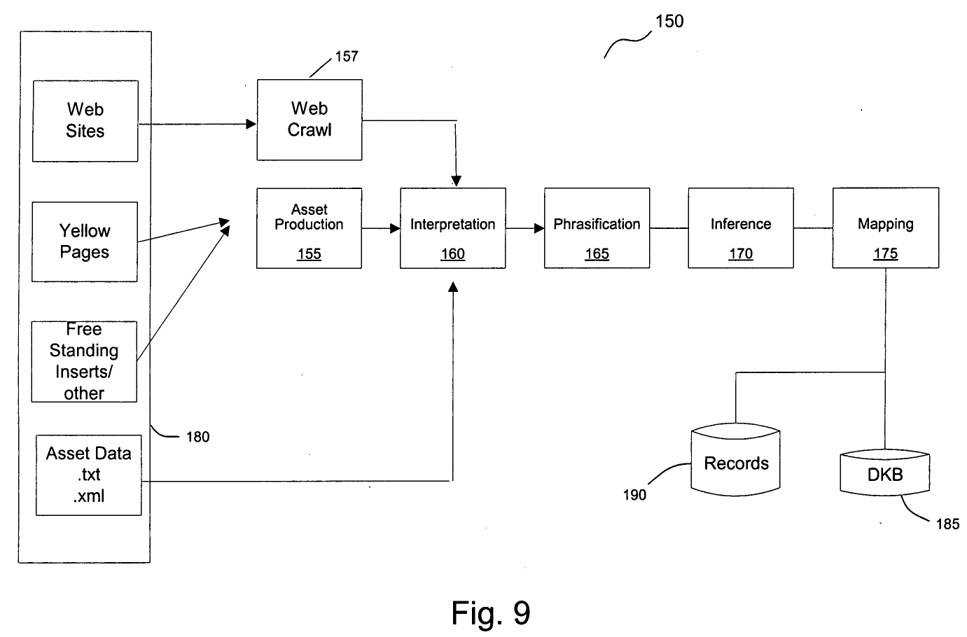

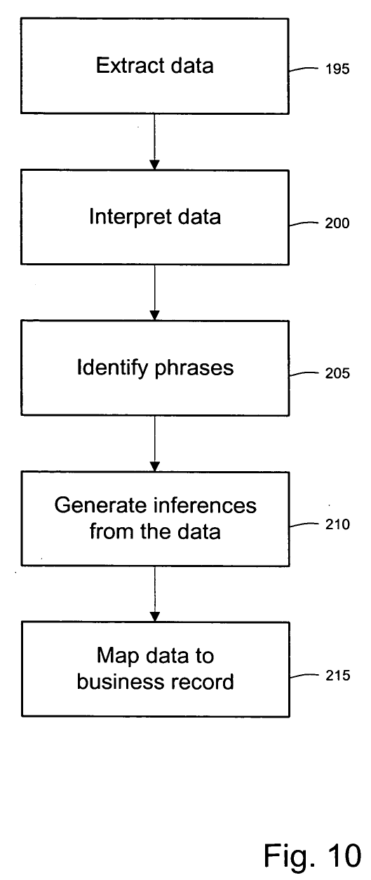

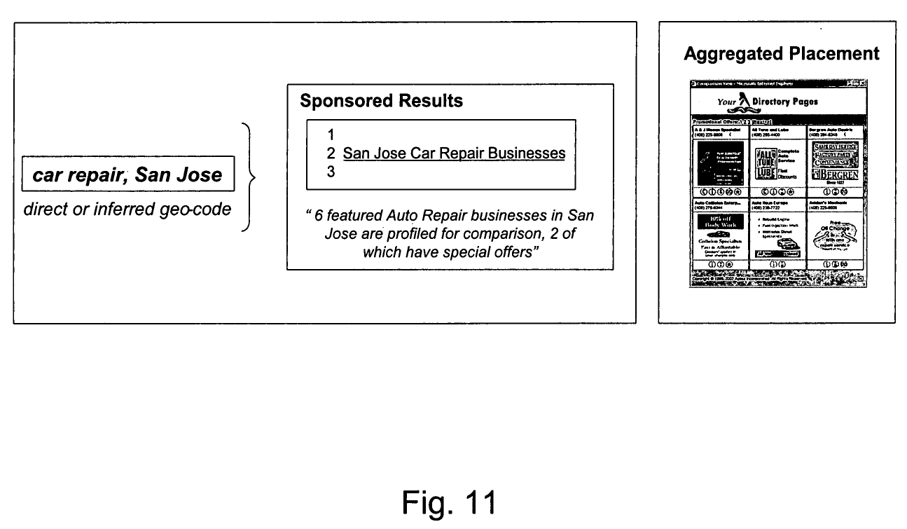

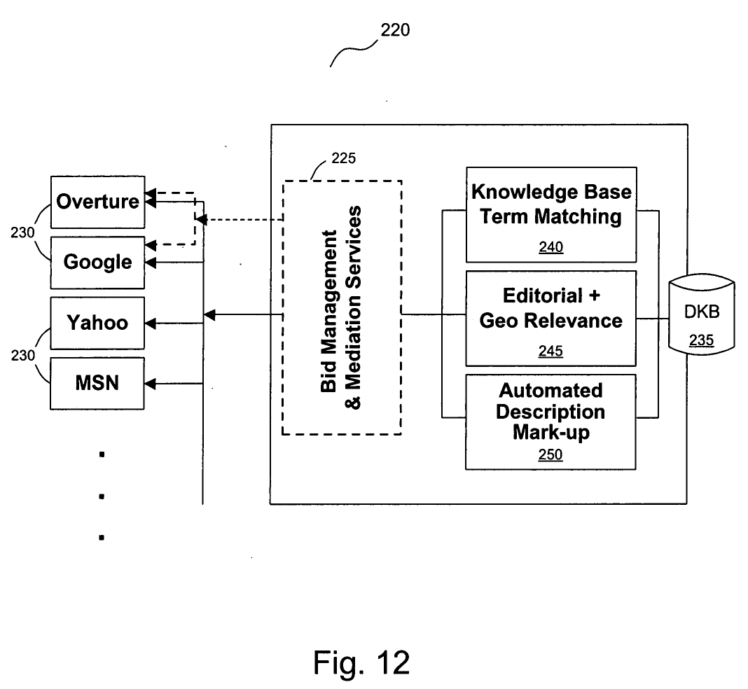

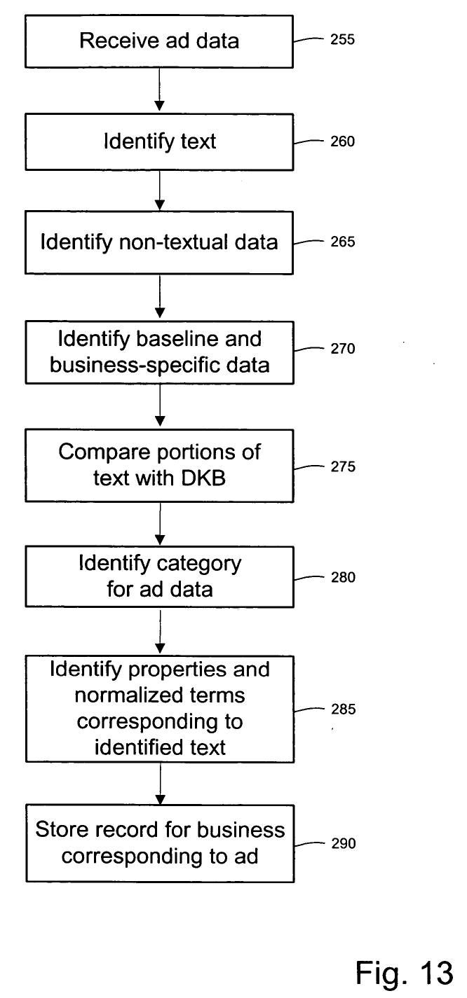

FIGS. 1-5 illustrate the user experiences enabled by the various embodiments of the present invention. FIGS. 6-8 illustrate the collection and organization of local data included in yellow-pages advertisements, newspaper advertisements, free standing inserts, business Web sites, TV advertisements, emails, etc. (collectively referred to as “business material”). FIGS. 9-10 illustrate an exemplary architecture and method for collecting data from business material. FIGS. 11-12 illustrate an exemplary system and method for aggregated placement of local-search information. And FIGS. 13-16 illustrate methods of operating embodiments of the present invention. Each of these figures is discussed below.

### Searching for Local Businesses

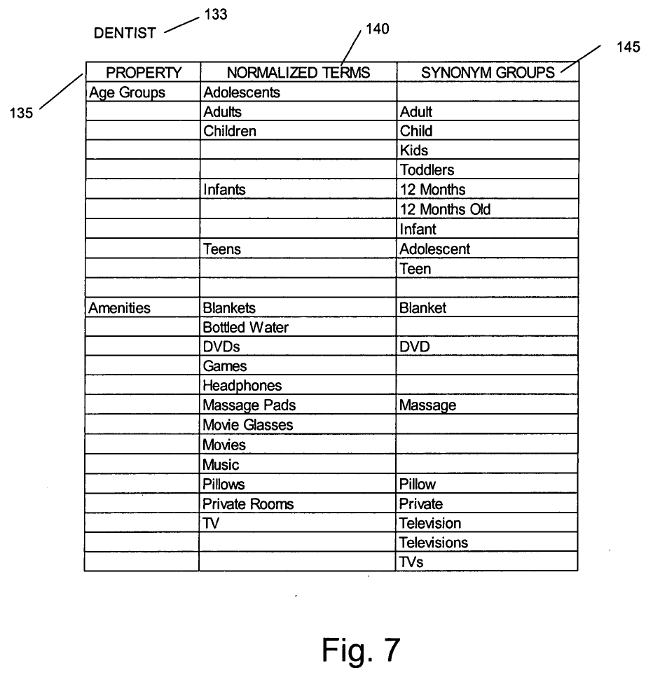

FIG. 1 illustrates a local search enabled by one embodiment of the present invention. For this local search, the user requested information on “San Jose, auto repair.” “Auto repair” is the search category and “San Jose” is the geographical limiter. These terms can be passed to a database that includes, for example, processed yellow-pages advertisements, processed free-standing inserts, processed newspaper advertisements, and/or information from business Web sites. The database can return all or a subset of businesses that match the search terms. In another embodiment, however, the user can also be presented with a list of properties to narrow the search. These properties can be based on a taxonomy that organizes business types and services. An exemplary taxonomy is shown in FIG. 7 and discussed herein.

Properties to narrow a search can also be extracted from a detailed search request such as “San Jose, BMW repair.” Embodiments of the present invention can automatically narrow the search by populating the “Vehicle Make” property field shown in FIG. 1 with “BMW.” Thus, the search is for the broad field “auto repair” and then narrowed based on “BMW.” Additionally, embodiments of the present invention can recognize corresponding terms such as “BMW car repair” and “European car repair.” In this system, a search for “BMW car repair” could return a business that advertises “European car repair” but not necessarily “BMW car repair.” The information to drive this synonym recognition is included in a business organization taxonomy, which broadly includes any type of organizational structure.

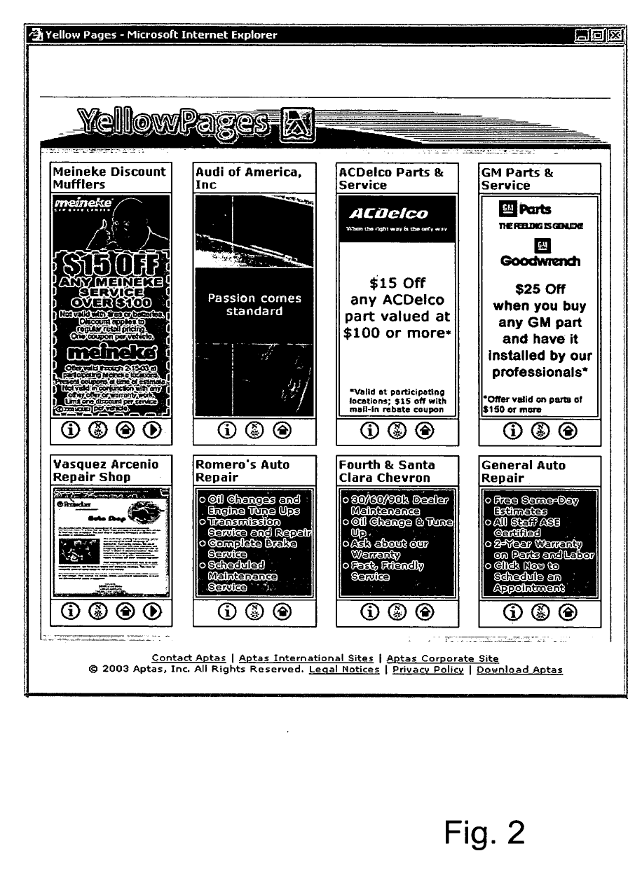

Referring now to FIG. 2, it is a result of a local search performed by one embodiment of the present invention. This result format is called “comparative browsing,” and it presents information in print-advertisement style. The comparative-browsing result shown in FIG. 2 is the result of a search for “San Jose, car repair.”

Links or images corresponding to promotions or other additional information can be displayed in the comparative format. Promotion information, for example, could be collected from newspaper advertisements or freestanding inserts and be used to supplement previously processed yellow-pages advertisements. The search results shown in FIG. 2, for example, show that Meineke™, AC DelCO™, and GM Parts & Services™ are all running promotions.

Advertisements displayed in the comparative format can list the information usually most relevant to the user. For example, the advertisements for Romero's Auto Repair and Fourth & Santa Clara Chevron list particular services offered by each business. If a user is searching for an “oil change,” both of these businesses advertise that they can perform the service. This service information can be gathered from print advertisements in the yellow pages, from Web sites, and/or from other documents. The displayed services are not necessarily a copy of a print document. Instead, they are often a dynamically generated list assembled specifically for a search result.

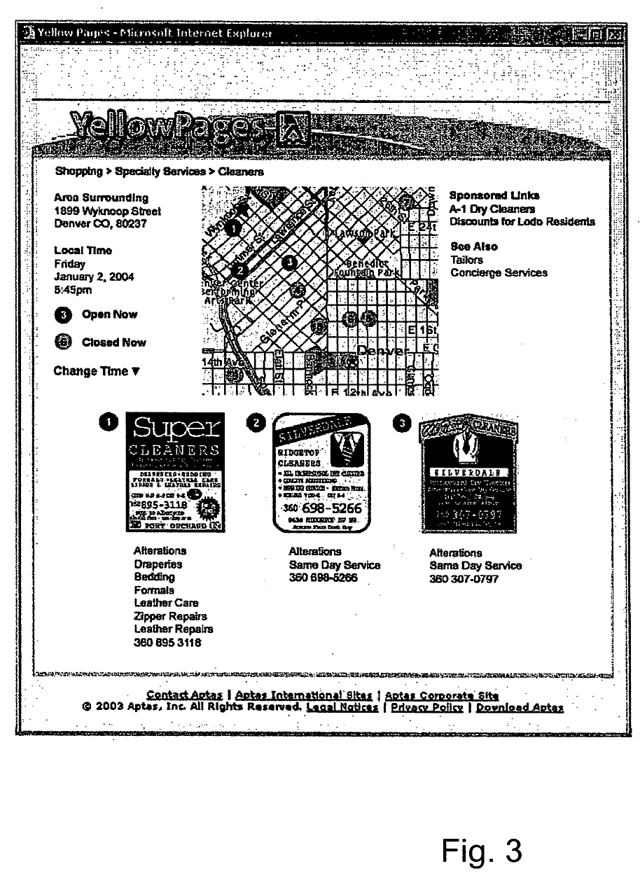

Referring now to FIG. 3, it illustrates another result of a local search performed by one embodiment of the present invention. This search result corresponds to a search for a dry cleaner near a particular address. The search result includes a list of dry cleaners and a map of where they are located. This particular embodiment also displays a copy of the print advertisement used by the currently-open dry cleaners along with a dynamically generated list of relevant data such as “draperies” and “same day service.” This relevant data is stored in the records database and could be mined from the print advertisements or Web pages associated with the particular dry cleaners.

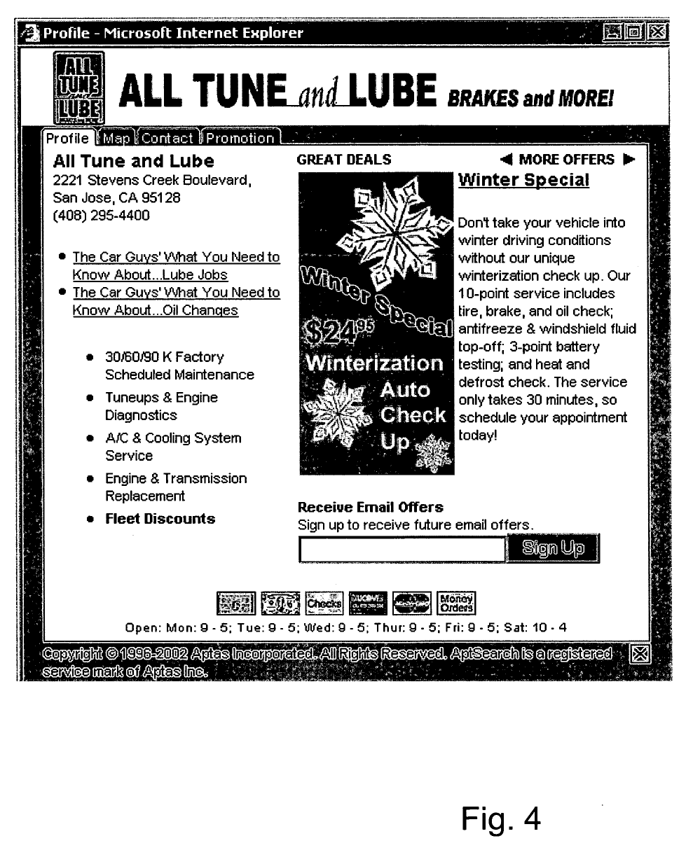

FIG. 4 is an active marketing page returned with results of a local search. An active marketing page is a Web page designed for integration with local search results. Active marketing pages are not necessarily meant to replace traditional business Web sites, but rather to offer Web-site capabilities to small businesses that might not otherwise have a Web site. Active marketing pages can also be scaled-down versions of traditional Web sites such as a Web site summaries or snapshots.

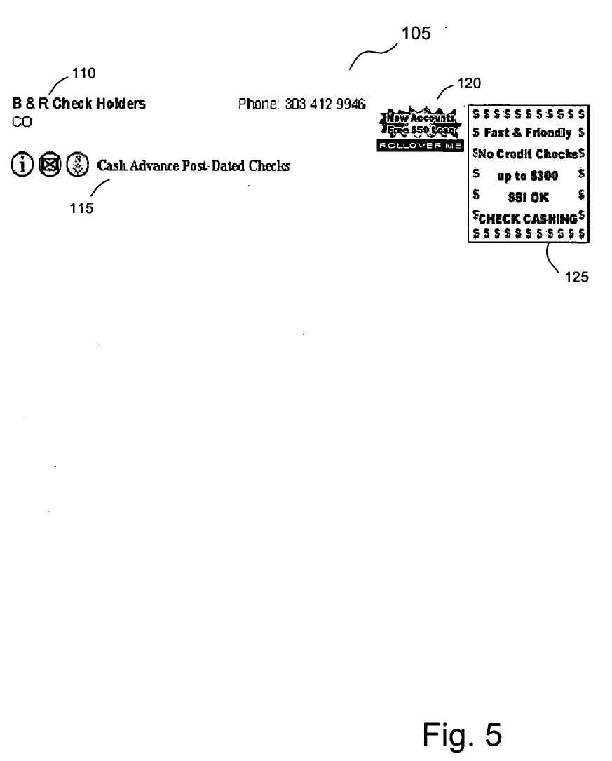

Referring now to FIG. 5, it is an example of an inline advertisement 105 returned with the results of a local search performed by one embodiment of the present invention. Several inline advertisements could be displayed simultaneously and could contain an active link to a copy of the print advertisement, Web site, or other information.

To maximize the amount of information displayed to the user, a typical inline advertisement can include four components: business identifier 110, tag line 115, inline display 120, and rollover detail advertisement 125. The data used to populate each of these components can be retrieved from the records database. Alternatively, particular portions of the inline advertisement can be specifically created for the inline advertisement.

### Structuring Local Business Data

Referring now to FIG. 6, it is an example of unstructured business material that could originate from a newspaper, Web site, free standing insert, video advertisement, the yellow pages, etc. Embodiments of the present invention can mine the relevant information from this advertisement and place it in a records database according to a business-structure taxonomy.

The advertisement in FIG. 6 includes several types of data that are important for electronic searches. For example, it includes business-specific information such as name, address, contact information, and hours of operation. The advertisement also includes baseline content that should be found in most auto dealer advertisements, including products, services, associations, and brands. Typically, all of this information is in an unstructured file such as an image file.

By collecting both business-specific information and baseline content from unstructured advertisements, the present invention can enable more intelligent searching and can distinguish between auto dealers more efficiently. For example, if a user is looking for a Chrysler™ dealer near Denver, Colo. with Saturday service, the present invention can identify the business advertising in FIG. 6 even though the advertisement is not in a text searchable format.

FIG. 7 is a chart 130 illustrating an exemplary format for organizing baseline content and business-specific content in the records database. This data can be stored in a directory knowledge database (“DKB”). By organizing business information according to a taxonomy, advertisement information can be easily cataloged, normalized, and searched. One embodiment of this type of taxonomy includes four levels: category 133, property 135, normalized term 140, and synonym group 145.

The “category” level corresponds to merchant structures such as “automotive repair” and “dentist.” Categories often correspond to yellow-pages headings or other standard business-organization schemes. The “property” level corresponds to the criteria by which consumers typically narrow their searches. For example, “services” and “vehicle type” are properties for the category “auto repair.” (See FIG. 1.) “Normalized” terms are words or groups of words specific to a category that are used as a selling point or differentiator. Finally, a “synonym group” includes synonyms for normalized terms. Synonym groups are beneficial because services advertised by different words can be identified by searching for any word in the synonym group. For example, one dentist can use the word “kids” and another “teens” to indicate that they work with children. “Children” is the normalized term and “kids” and “teens” are the synonym group. Synonym groups can be derived from the different terms in the yellow page or other documents. They can also include typical synonyms such as shortened spellings and slang.

Informational data can be attached to any level in a taxonomy. Typical informational data includes events, purchase types, and geographic relevance. “Events,” for example, indicates life events such as marriage, birth, surgery, home purchase, etc. and interrelates certain categories, properties, or terms in a taxonomy. The “home purchase” event, for example, could be attached to the categories “mortgage broker” and “home inspector.” Similarly, “purchase types” defines relationships between similar categories, properties and/or terms based on consumer purchasing habits. As for “geographic relevance,” it is discussed in more detail below. Generally, however, it indicates whether geography is relevant for particular levels in the taxonomy and if so, how far a user might travel for a particular product or service.

This attached informational data can be used to refine a user's search or to return additional business listings that might be relevant to the user. It can also be used for targeted advertising. For example, if a user searches for “wedding cake, Denver,” embodiments of the present invention can determine that “wedding cake” is a property of the category “baker.” The present invention could then identify the events—likely “weddings”—attached with the “baker” category and/or the “wedding cake” property. This embodiment of the present invention could then search the DKB for other categories, properties, or terms attached, for example, to the “wedding” event. The list of related categories or properties could then be displayed for the user. The user could then select services of interest and receive a list of appropriate businesses. Alternatively, the user could be presented a list of targeted advertisements related to the “wedding” event.

In other embodiments, the user can select an event or purchase type from a list. For example, the user could select “wedding” from the events list. The present invention could then search the DKB for categories, properties, or terms to which the “wedding” event has been attached. The results, or partial results, of that search could be returned to the user. A typical search result for the “wedding” event could list “cakes,” “tuxedos,” “dresses,” and “limousines.” This list can then be used to identify related businesses.

In addition, to enable user searches at the event level, “event” informational data may be triggered for use by user searches on any category within a given taxonomy. For instance, the search term, “wedding dress,” would trigger bridal gowns as a part of the wedding taxonomy and search results could include local businesses that sell wedding dresses along with businesses that are commonly associated with weddings such as bakeries, limousines, formal wear and photographers.

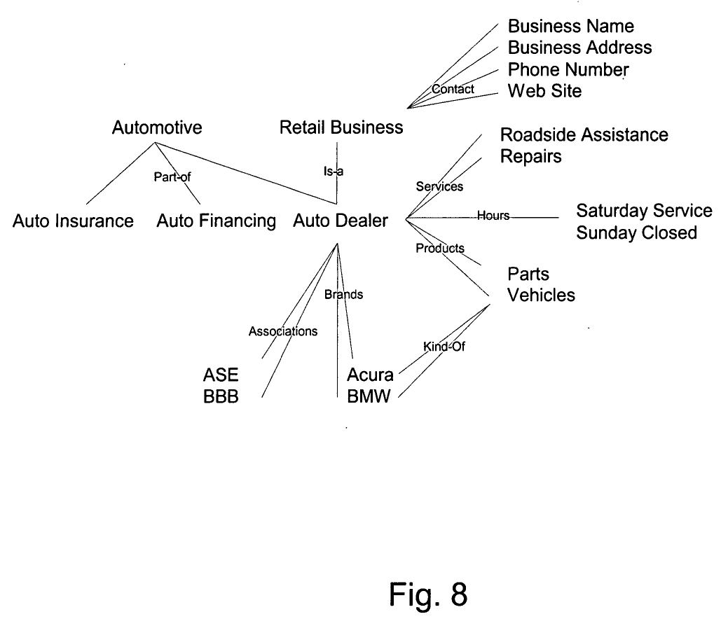

Referring now to FIG. 8, it is a chart showing exemplary relationships between exemplary taxonomy levels. Categories, properties, normalized terms, and synonym groups can be assigned or inherited in several ways. For example, the “age group” property shown in FIG. 7 is not unique to dentists. It also applies to doctors. Accordingly, the property “age group” can be assigned to both doctors and dentists. This assignability helps ensure uniformity between different but similar categories in the taxonomy. Because the category “doctors” inherits the property “age group,” it can also inherit the corresponding normalized terms and synonym groups. Normalized terms and synonym groups can also be inherited individually.

FIG. 8 illustrates how data in the taxonomy can be inherited and related on various levels. For example, “automotive,” “auto insurance,” “auto financing,” and “auto dealer” are all categories. These categories can be interrelated by defining particular relationships between them such as structural, taxonomic, production, sales, marketing, equivalence, and identity. For example, properties such as “contact information,” “services,” “products,” “brands,” and “associations” can be associated with a particular category such as “auto dealer.” And by defining a relationship between “auto dealer” and “automotive,” these properties are also related to the “automotive” category. These flexible relationships can enable powerful relevance searching.

### Collecting and Processing Business Data

Referring to FIGS. 9 and 10, this embodiment of the present invention mines, organizes, and stores business data in a records database. The basic architecture 150 includes five processing components. These five components include the asset production unit 155, the interpretation unit 160, the phrasification unit 165, the inference unit 170, and the mapping unit 175. Each unit is discussed below.

The asset production unit 155 is responsible for converting unstructured content to structured content. For example, it is responsible for converting data 180 such as free standing inserts, newspaper ads, classified ads, TV ads, yellow-pages listings, and business Web sites to a structured text format. Several file formats can be processed by the asset production unit, including encapsulated postscript (EPS) files, extensible markup language (XML) and portable document file (PDF). Other file formats such as XML, HTTP, TXT, and RSS are pre-formatted so extraction is not necessary. Data provided in these format types can be processed directly into the interpretation unit. Moon Valley Software located in Grover Beach, Calif. produces an exemplary program for processing EPS files. The asset production unit 155 is also capable of crawling Web sites and extracting relevant information based on the taxonomy or other structure for the corresponding business category. Alternatively, a Web crawl unit 157 can crawl the Web site.

When processing textual data, the asset production unit 155 generally captures one continuous string of letters and passes it to the inference unit. (Block 195) The asset production unit 155, however, captures information beyond textual data. It can also capture context data. For example, the asset production unit 155 can determine the layout of an advertisement by identifying the X-Y coordinates for each letter, word, phrase, or image. These X-Y coordinates can be relative to an individual advertisement and/or relative to an entire page of advertisements. Similarly, the asset production unit 155 can identify the font, size, style, case, bulleting, composition, knockouts, and/or color of each letter, word, phrase, or list in a particular advertisement. This context information can convey the relative importance of different parts of the advertisement and can be used to weigh certain terms. This information can also be used to reconstruct documents.

Embodiments of the present invention can also identify the location of the letters or words relative to an image within an advertisement. This locational information helps provide context about captions for images in the advertisement. Further, the asset production unit 155 can determine the size of a particular advertisement and its placement on a page relative to other advertisements.

The continuous string of text data and possibly positional data captured by the asset production unit 155 can be passed from the asset production unit 155 to the interpretation unit 160, which identifies the individual words in the string. One embodiment of the present invention identifies individual words by looping through the text string letter by letter and comparing groups of letters against a dictionary of terms. For example, the asset production unit 155 might collect the following information from the advertisement in FIG. 6:
salesservicebodyshoppartsleasingSaturdayService8 am-5 pm.
   The interpretation unit 160 could separate this string into its individual phrases and could do so by looping through the letters and comparing groups of letters against a dictionary or other collection of terms. (Block 200) When the interpretation unit 160 identifies a word, that word is passed to the phrasification unit 165. In some embodiments, the positional information about the word is also passed to the phrasification unit 165. This type of data can also be collected from structured documents.

Generally, the interpretation unit 160 does not read the words in context. Stated differently, the interpretation unit 160 is generally unaware of how a term is used in a document. For example, the interpretation unit 160 might recognize that the words “body” and “shop” appear together in the string of words generated for an auto repair advertisement. But it will not necessarily recognize that the two words are a single phrase, “body shop.”

To identify phrases, the phrasification unit 165 can compare words or groups of words against a phrase dictionary or a directory knowledge base 185. (Block 205) The phrasification unit 165 can use positional information to identify words that are near each other but not necessarily arranged in a linear fashion. These identified words can then be passed to a phrase dictionary. The phrase dictionary can be generic or specific to a particular type of business. In one embodiment, the phrase dictionary is generated by recognizing that words appear together in certain types of advertisements, e.g., “root” and “canal.” To build this type of phrase dictionary, several hundred advertisements for a particular type of business may need to be processed.

The words and phrases identified by the interpretation 160 and phrasification units 165 can be passed to the inference unit 170, which determines their meaning to a user. (Block 210) The inference unit 170 searches the words and phrases for business-specific information such as name, address, hours of operation and phone number. Assuming that the inference unit 170 is aware of the type of business described in an advertisement, it can look for words and phrases common to that type of business. For example, if the inference unit 170 is aware that it is processing an advertisement for an auto repair shop, it will look for services and synonyms for common auto repair services. The inference unit 170 can also be configured to determine the type of business corresponding to an advertisement by analyzing the words and phrases received from the interpretation 160 and phrasification units 165.

In another example, the inference unit 170 can recognize that an advertisement states “open 7-7” and infer that the business is open early and late by comparing this phrase against a list of common phrases for hours of operation. This inference enables better and more standardized searching because a user can search for “open early” or “open late” and identify appropriate businesses that do not use that exact language in their advertisements. In another example, the inference unit 170 can recognize that an advertisement that states “open 365 days a year,” indicates that the business is open on Saturday and Sunday even though the advertisement does not expressly say so. The inference engine can also analyze context for certain advertising terms. For example, “open late” means something very different for a night club and a dry cleaner.

The inference unit 170 can also be trained to identify other types of information such as years of experience. For example, if an advertisement states “operating since 1980” or “in business since 1980” then the inference unit 170 can recognize the data and the context words (“operating since,” or “in business since”) and list the business as operating for 20+years. And in other embodiments, the inference unit 170 can separate compound phrases into individual phrases. For example, if an advertisement states “residential and commercial cleaning,” the inference unit 170 can separate this phrase into “residential cleaning” and “commercial cleaning.” Consumers can then search on either service. In yet other embodiments, the inference unit 170 can recognize logos or slogans and infer their meaning. For example, if the asset production unit 155 extracts a VISA™ logo, the inference unit 170 can infer that the business accepts VISA by comparing the logo against a database that contains typical business logos.

Although not illustrated in FIG. 9, some embodiments of the present invention include a manual ontology unit for manually handling information that the interpretation, phrasification, and/or inference unit cannot properly process.

The information collected about an advertisement by the interpretation, phrasification, and inference units can be stored as individual business records in a record database 190. (Block 215) Each record can include the raw data and/or the processed data for a particular business. Generally, the processed data is organized according to the taxonomy previously discussed and is typically stored in a structural format such as XML. If multiple advertisements are collected for the same business, the collected information can be aggregated together in the same business record. Conflicts between the data can be resolved according to priority rules.

### Crawling Web Sites in Context

Records can also be added to the records database by crawling Web sites and other data in a structured format. The difficulty in searching these types of records is that they generally have more information than is necessary for a business search. The information in a typical Web site, for example, needs to be summarized for a business search. Embodiments of the present invention enable this summarization by crawling business Web sites in context. Stated differently, the present invention can search a Web site looking for relevant information as identified by a taxonomy or other business structure. This summary information can be presented in a summary Web page, made available for electronic searching, or combined with an existing business record in the record database 190.

For example, a Web site for a dentist could be crawled to discover information that is identified in the taxonomy for dentists. In one example, the Web site could be searched for words included in the synonym groups or normalized terms corresponding to the “dentist” category.

Once relevant data is identified in the Web site, it can be passed to the inference engine for proper consideration. If, for example, Web crawling returns “12” and “months,” the inference unit can recognize (1) that these words form the phrase “12 months” and (2) that “12 months” is a synonym for the normalized term “infants.” This information can be mapped to the “age group” property of a new record or could be used to update an existing record for the dentist. Priority rules could govern whether one data source is deemed more reliable than another.

In an exemplary Web crawling process, a Web site is first crawled and indexed in a traditional fashion. This process is well known and not described further. Embodiments of the present invention can then process this indexed data using the taxonomy (e.g., category, property, normalized term and synonym group) corresponding to the business category. Manual intervention may also determine what types of data should be extracted from a Web site. Additionally, the indexed data can be searched for content types such as resumes, publications, calendars, catalogs, coupons, or menus. The particular content types for which to search can be stored in the DKB with the appropriate category or property. The category “attorney”, for example, may indicate that content types “resumes” and “publications” are relevant. Thus, when crawling a law-firm Web site, the present invention would search for content types “resumes” and “publications.”

Other embodiments are configured to recognize patterns associated with categorizing properties or terms in the DKB. These patterns identify how information could be presented in a Web site. Attorney biographical information, for example, could be listed under the heading “biographies” or “attorneys.” If both of these terms were attached to the “Attorney” category in the taxonomy, the context crawling process would search this branch of the Web site for attorney bibliographic information.

In other embodiments of the present invention, the crawling process searches for particular electronic commerce capabilities. For example, the crawling process can be configured to search for registration systems, calculators, shopping carts, etc. Particular types of electronic commerce capabilities can be attached to various levels of the taxonomy.

### Relevance Logic for Local Searches

Embodiments of the invention also include advanced relevance logic for local searches. This relevance logic helps narrow search results based on common behavior of consumers and includes geographic limitations and time sensitivity. For example, if a user is searching for “San Jose, drapery cleaning,” the relevance logic can identify the business category as “dry cleaners” by searching for “drapery cleaning” in the DKB and retrieve a list of appropriate businesses. This list could then be narrowed by filtering according to search-specific criteria. Typical criteria can include a radius limitation unique to this type of business. A customer, for example, might drive 10 miles for an auto dealer but only two miles for a dry cleaner. This type of distance limitation can be attached to various levels in the taxonomy. For example, a ten-mile radius could be attached to the category “auto dealer.”

Standard radius limitations can also be adjusted according to a user's environment. A typical adjustment depends on population density. A customer located in a large city, for example, might only drive 1 mile for a dry cleaner. But a customer located in a rural area might drive 20 miles. This adjusted radius limitation can be calculated in various ways. For example, the radius limitation can be calculated based on a ratio of the population density for the user's area to an average population density. Other factors that can be used to adjust or calculate a radius limitation include the importance of distance independent of the user's location, importance of distance relative to a user's typical location, importance of distance relative to the user's current location, importance of distance to driving path.

Radius limitations can be calculated relative to several locations, including home address, work address, and drive path. The user's location or a target location can be determined by latitude/longitude, zip codes (preferably zip+4), IP location estimation, location services (such as cell tower triangulation), identity management, etc.

Other search-specific criteria usable for navigating search results include hours of operation, traffic issues, and promotion sensitivity. For example, customers often use coupons for oil changes. A typical customer might drive 10% farther than normal to use an oil change coupon. All of this information could be attached to the appropriate level in the taxonomy stored in the DKB.

### Aggregated Advertisment Placement

As previously discussed, traditional search engines are notoriously ineffective for local searches. But because of their market presence, consumers still use them. Embodiments of the present invention can combine local search as described above with these traditional search engines to provide a better consumer experience.

One problem with traditional search engines is that they generate revenue by allowing businesses to bid for relevant search terms and be placed higher in the results list for certain searches. For example, an auto repair shop in San Jose could bid for the terms “auto repair” together with “San Jose.” Assuming that the bid is competitive, when someone enters “auto repair, San Jose” in the search engine, the bidding auto repair shop should be among the first listed in the search results.

Unfortunately, this model of bidding for search terms is complex and often too expensive and time consuming for small businesses. These small businesses instead tend to rely on traditional marketing such as the yellow pages and free standing inserts as their primary method of advertising. And as a result, their own Web page—assuming that they have one—may be ignored or minimized by the traditional online search engines.

FIG. 11 illustrates one solution to the problem. This solution allows the yellow page publisher, or any other entity, to bid on key words for a group of similar businesses. For example, the yellow-pages publisher could purchase “auto repair” together with “San Jose.” When a user enters these words into a traditional search engine, a yellow-pages link would be one of the first listed. Instead of being associated with just one business, however, the yellow-pages link could be associated with several businesses. The advertisements for these businesses could be aggregated together as a single page. Thus, by selecting the yellow-pages link in the search result, the user can view the aggregated-advertisement page.

The advertisements displayed in an aggregated-advertisement page are identified using the local search techniques described above and/or can be selected based on a pay-for-placement model at the yellow-pages level. Businesses can, for example, purchase certain levels of online placement when they are purchasing their yellow-pages advertisement. In one embodiment, the yellow-pages publisher would be generally responsible for bidding on the relevant key words necessary to guarantee the local business certain placement in the search results.

FIG. 12 illustrates the system 220 and process for automatically purchasing key words on traditional search engines. This embodiment uses a bid management and mediation service 225 to evaluate and compare bid alternatives across multiple search engines 230. This unit also manages and tunes bid strategies for the key term on which it is bidding.

The key terms for which to bid are identified using the data in the DKB 235. For example, the key terms correspond to the normalized term or the synonym group. Three components are used to identify these terms: knowledge base term matching 240, editorial and geographic relevance 245, and automated description mark-up 250.

### Methods of Operation

FIGS. 13-16 illustrate several exemplary methods of operating embodiments of the present invention. These methods can be performed in hardware and/or software. Additionally, these methods can be performed in a single system or a distributed system.

Referring first to FIG. 13, it illustrates one method for creating business records using the DKB. In this embodiment, the text of a received advertisement is identified and extracted. (Blocks 255 and 260) Embodiments of the present invention can also capture font size, color, images, etc. associated with the text. (Block 265)

Next, the business-specific data and the baseline data can be identified and extracted from the text data. (Block 270) This information can be used to create a new business record or to identify an existing record that should be updated. The remaining text can be compared to the taxonomy in the DKB to determine a category associated with the business. (Blocks 275 and 280)

After identifying the business category associated with the advertisement, the text of the advertisement can be compared against the synonym groups associated with that category. (Block 285) An entry in the record of the identified business can be created for each match between the synonym group and the advertisement text. The entry often includes a set flag for a particular normalized term. In other instances, the entry includes text indicating, for example, a range of values or dates. Any of these entries can be stored along with a weighting that indicates whether the original text from the advertisement included special features such as font type, font size, etc. (Block 290)

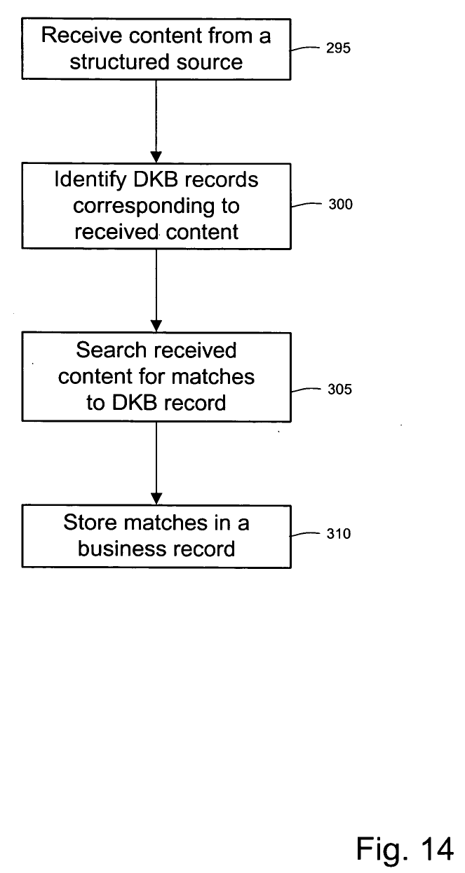

Referring now to FIG. 14, it illustrates a method of creating or supplementing business records by searching structured data such as Web pages. In this embodiment, a URL for a Web page is initially identified. The URL could be collected from a business directory, a yellow-pages ad, or another service. Using the URL, the Web site can be crawled and a traditional index created. (Block 295) The index data can then be crawled for content such as business name, address and hours. The index data can also be crawled in the context of the DKB taxonomy. (Blocks 300 and 305) For example, the index data can be crawled for matches with synonym groups in the DKB. The baseline content and any matches can be integrated into an existing business record or used to create a new record. (Block 310)

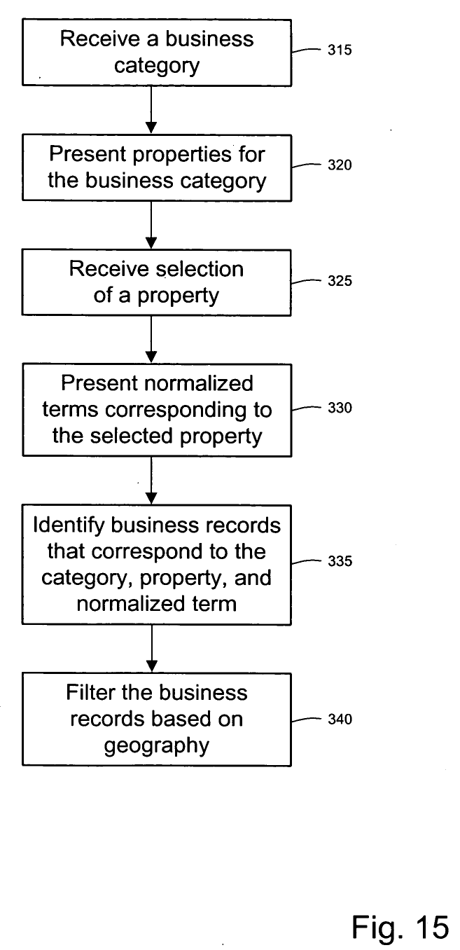

Referring now to FIG. 15, it illustrates one method of searching business records using the DKB. In this embodiment, a user initially selects a business category from, for example, a drop down list. (Block 315) The user can then be presented with a list of properties that corresponds to the selected category. (Block 320) The user can select one of the presented properties and then be presented with a list of normalized terms. (Blocks 325 and 330) The user can select one of the normalized terms, and the records database can then be searched using the selected category, property, and normalized term. (Block 335) In other embodiments, the records database can be searched using any one of the taxonomy levels.

Any records identified by the search can be filtered based on geography. In one embodiment, the records are filtered based on the location of the user and the geography limitations associated with the particular category or property used for the search. (Block 340)

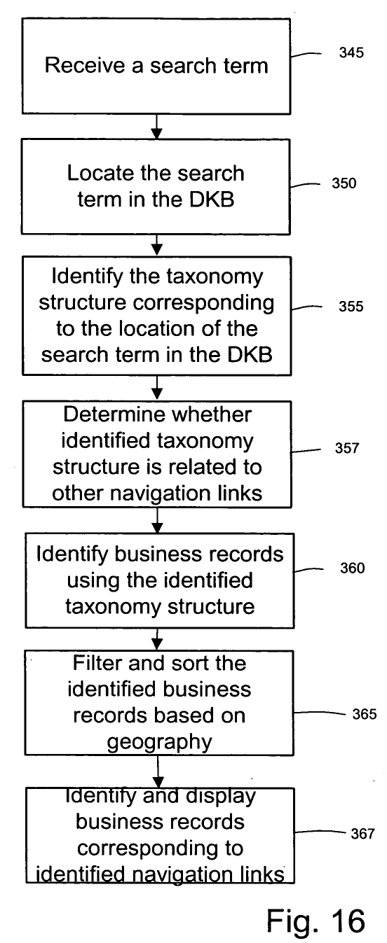

Referring now to FIG. 16, it is a flowchart of another method for searching business records using the DKB. In this embodiment, the user enters a search term into a text box. (Block 345) The search term is then compared against the DKB. (Block 350) If a match is found in the DKB, the other taxonomy levels associated with the search terms are identified. (Block 355) For example, the normalized term, the property, and/or the category corresponding to the search term are identified. One or all of these identified taxonomy levels can then be used to search the actual business records. (Block 360) In one embodiment, navigation links (such as events and purchase types) associated with these taxonomy levels are identified. (Block 357) These links can be used to identify related business or to target advertisements. Any matching business records can be filtered and ranked based on numerous relevance criteria including, but not limited to: events, purchase type, geography, word match, user demographics, and geographic proximity. (Block 365) The appropriate records can be displayed along with information related to the navigation links. (Block 367)

In conclusion, the present invention provides, among other things, a system and method for enabling searches of structured and unstructured data using taxonomies and other structures. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

1. A method for searching comprising:
receiving a search term comprising a product term and a geography limitation;
identifying a normalized term corresponding to the product term;
identifying a first set of records corresponding to the normalized term;
sorting the first set of records according to the geography limitation;
returning at least some of the first set of records according to the sort;
identifying navigation links corresponding to the normalized term;
identifying a second set of records corresponding to at least one of the navigation links; and
returning at least some of the second set of records.

2. The method of claim 1 wherein receiving the search term comprises:
receiving a product category and a geography limitation.

3. The method of claim 1 wherein receiving the search term comprises:
receiving a service category and a geography limitation.

4. The method of claim 1 wherein identifying the normalized term comprises:
comparing the product term against a list of synonyms.

5. The method of claim 1 wherein returning at least some of the first set of records according to the sort comprises:
transmitting at least some of the first set of records for display.

6. The method of claim 1 wherein identifying navigation links comprises:
identify event types corresponding to the normalized term.

7. The method of claim 1 wherein identifying navigation links comprises:
identify event types corresponding to the normalized term.

8. The method of claim 1, wherein the second set of records includes advertisements.

9. The method of claim 1, further comprising:
presenting an indication of the second set of records to a user;
receiving a selection from the user corresponding to at least one of the second set of records; and
retrieving information related to the received selection.

10. A method of searching comprising:
receiving a search a term comprising a product term;
identifying a normalized term corresponding to the product term;
identifying a navigation link corresponding to the normalized term;
identifying business records associated with the navigation link; and
returning at least some of the identified business records.

11. The method of claim 10, further comprising:
determining whether a geographical limitation is associated with the normalized term; and
sorting the identified business records according to the geographical limitation.

12. The method of claim 11, wherein sorting the identified business records comprises:
filtering the identified business records.

13. A system for identifying records, the system comprising:
at least one processor;
a plurality of instructions configured to cause the at least one processor to:
identify a normalized term corresponding to a product term received in a search;
identify a navigation link corresponding to the normalized term;
identify business records associated with the navigation link; and
return at least some of the identified business records.

14. The method of claim 13, wherein the plurality of instructions are further configured to cause the at least one processor to:
present an indication of the second set of records to a user;
receive a selection from the user corresponding to at least one of the second set of records; and
retrieve information related to the received selection.

15. A system for searching comprising:
means for receiving a search a term comprising a product term;
means for identifying a normalized term corresponding to the product term;
means for identifying a first set of records corresponding to the normalized term;
means for sorting the first set of records according to the geography limitation;
means for returning at least some of the first set of records according to the sort;
means for identifying navigation links corresponding to the normalized term;
means for identifying a second set of records corresponding to at least one of the navigation links; and
means for returning at least some of the second set of records.
